(19) United States
(12) Patent Application Publication
(10) Pub. No.: US 2025/0094216 A1
(43) Pub. Date: Mar. 20, 2025

(54) Method and electronic device for managing the execution of software application services on an avionics platform, related computer program and avionics system

(71) Applicant: THALES, Meudon (FR)

(72) Inventors: Pierre HARAMBILLET, MERIGNAC (FR); Guillaume CALLEWAERT, MERIGNAC (FR); François MICHEL, MERIGNAC (FR)

(21) Appl. No.: 18/884,112

(22) Filed: Sep. 13, 2024

(30) Foreign Application Priority Data
Sep. 20, 2023 (FR) 2309968

(51) Int. Cl. G06F 9/48

(52) U.S. Cl. CPC G06F 9/4881

(57) ABSTRACT

A method of managing the execution of software services on an avionics platform including resources for the execution of the services is implemented by an electronic device and includes acquisition of contextual data for a group of software services to be executed, the contextual data including, for each software service: a maximum number of resources used by the service, an operating requirement of the service equal to resistance to breakdown/s or non-resistance to breakdown/s, and, if the operating requirement of the service is equal to resistance to breakdown/s, a number of breakdown/s the service should withstand, computation, from the acquired contextual data, of a context for the group of software services, and launching of the execution of software service/s of the group according to a set of distribution rule/s of the services and depending upon the computed context.

### CROSS-REFERENCE TO RELATED APPLICATION

This application is a U.S. non-provisional application claiming the benefit of French Application No. 23 09968, filed on Sep. 20, 2023, which is incorporated herein by reference in its entirety.

### TECHNICAL FIELD OF THE INVENTION

The present invention relates to a method for managing the execution of software application service/s on an avionics platform intended to be on-board an aircraft, the avionics platform including resources for the execution of said software services, the method being implemented by an electronic management device; as well as a non-transitory computer-readable medium including a computer program including software instructions which, when executed by a computer, implement such a management method.

The invention further relates to such an electronic device for managing the execution of software application/s services; and to an avionics system comprising such an avionics platform and such an electronic management device.

### BACKGROUND OF THE INVENTION

Today's software applications are no longer monolithic, and are usually composed of many software components, also called software services, working together to enable the software application to function properly. Each software service is generally encapsulated in a container forming an executable file. Software services are, e.g., services compatible with the Kubernetes system, which is a free software system (open-source) that automates the deployment, the scaling and the management of applications in containers, the containers being called pods in the Kubernetes system.

The electronic management device, also called an electronic orchestration device or orchestrator, then serves to manage the execution of software services on a computer platform, such as an avionics platform.

Current orchestrators are generally intended to operate in data-centers with multiple computer servers with large resources, where it is possible to add software services on demand, simply by updating the resources needed for all software services.

However, such orchestrators are not suitable for operating correctly in an environment where the hardware resources are limited, in particular when the platform is intended to be carried on-board an aircraft.

### SUMMARY OF THE INVENTION

The goal of the invention is then to propose a method, and an associated electronic device, for managing the execution of software services of software application/s on an avionics platform, for better managing the execution of software services with limited resources and then for improving the operation of the platform.

To this end, the invention relates to a method for managing the execution of software application service/s on an avionics platform intended to be carried on-board an aircraft, the avionics platform comprising resources for the execution of said software services, the method being implemented by an electronic management device and comprising the following steps:
acquisition of contextual data for a group of software services to execute on the avionics platform;
   the contextual data including, for each software service: a maximum number of resources used by said service; an operating requirement of said service equal to resistance to breakdown/s or non-resistance to breakdown/s; and if the operating requirement of said service is equal to resistance to breakdown/s, a number of breakdown/s to which said service has to be resistant;
computation, from the acquired contextual data, of a context for the software service group;
launching of the execution of one or a plurality of software services of the group according to a set of distribution rule/s of software services on the platform and depending upon the computed context.

With the management method according to the invention, the computation of the context from the contextual data acquired, the latter comprising, for each software service, a maximum number of resources allocated to the service, an indication according to which the service should or should not be resistant to one or a plurality of breakdowns, and, where appropriate, the number of breakdown/s to which same should be resistant, then the launching of the execution of software service/s of the group according to the context computed and according to a set of distribution rule/s on the platform, serves to distribute in the best way the resources of the platform between the software services of the group when the resources are limited.

More particularly, only certain software services are then likely to be executed by ensuring that the sum of the maximum numbers of resources used by the executed services does not exceed the available number of resources and/or by giving priority to the service/s that should withstand one or a plurality of breakdowns.

According to other advantageous aspects of the invention, the management method comprises one or a plurality of the following features, taken individually or according to all technically possible combinations:
during the computation of the context, a level of priority is computed for each software service, respectively, the level of priority being higher for a service with an operating requirement equal to resistance to breakdown/s than for a service with an operating requirement equal to non-resistance to breakdown/s;
   the level of priority preferably depends on the number of breakdown/s the service should withstand;
   the level of priority for a service which should withstand N+1 breakdowns is again preferably higher than the level of priority for a service which should withstand N breakdown/s, N being an integer greater than or equal to 1;
the set of distribution rule/s includes one or a plurality of rules from the group consisting of: a first rule according to which the execution of a service of higher level of priority takes precedence over the execution of a service of lower level of priority; a second rule according to which the available number of resources of the platform is greater than or equal to the sum of the maximum numbers of resources used by the software services executed; and a third rule according to which the number of resources available after N breakdown/s is greater than the sum of maximum number/s of resources used by the maximum number/s of resources used by the service/s which should withstand N breakdown/s, N being an integer greater than or equal to 1;
   the set of distribution rule/s preferably including all the rules in the aforementioned group;
the context of each software service depends on a phase of flight of the aircraft, and
   wherein the method further comprises, at each change of phase of flight with implementation of a subsequent phase of flight, the computation of a subsequent context for the subsequent phase of flight;
   the software service/s executed in the subsequent phase of flight depending upon the computed subsequent context; the execution of the software service/s executed in the current phase of flight and no longer to be executed in the subsequent phase being then stopped and the execution of the software service/s to be newly executed in the subsequent phase being launched;
the level of priority of each software service depends on the phase of flight of the aircraft, and
   wherein subsequent levels of priority of the software services are computed for the subsequent phase of flight when computing the subsequent context; and the software service/s executed during the subsequent phase of flight then depend on the computed subsequent levels of priority;
the method further comprises a step of stopping the execution of the software service/s with the lowest priority, if the number of resources available is insufficient to launch the execution of a new software service;
the software service/s with the lowest priority are the software service/s with the lowest level/s of priority;
the contextual data also include, for each software service: if the operating requirement of said service is equal to non-resistance to breakdown/s, a level of availability of said service; and
   the software services all have the lower priority for the execution thereof as the level of availability is low;
the method further comprises, before the acquisition step, a step of determining the group of software services to be executed, including the reception of a new group of software services, the verification of the received group of software services according to a predefined set of verification rule/s, and if the received group of software services is considered correct during the verification, then same forms the group of software services to be executed; the group of software services being otherwise unchanged.

The invention further relates to a non-transitory computer-readable medium including a computer program including software instructions which, when executed by a computer, implement a management method as defined above.

The invention further relates to an electronic device for managing the execution of software service/s of software application/s on an avionics platform intended to be carried on-board an aircraft, the avionics platform including resources for the execution of said software services, the electronic management device comprising:
an acquisition module configured to acquire contextual data for a group of software services to be executed on the avionics platform;
   the contextual data including, for each software service: a maximum number of resources used by said service; an operating requirement of said service equal to resistance to breakdown/s or non-resistance to breakdown/s; and if the operating requirement of said service is equal to resistance to breakdown/s, a number of breakdown/s to which said service has to be resistant;
a computation module configured to compute, from the acquired contextual data, a context for the group of software services;
a launch module configured to launch the execution of one or a plurality of software services of the group according to a set of distribution rule/s of software services on the platform and depending upon the computed context.

The invention further relates to an avionic system suitable for being carried on-board an aircraft, comprising:
an avionics platform with resources for the execution of software services of software application/s; and
an electronic device for managing the execution on said platform of software services of software application/s, the electronic management device being as defined hereinabove.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a schematic view of an aircraft comprising an avionics platform including resources for the execution of software services of software application/s; an electronic box forming the avionics platform, the box including a backplane board and a plurality of electronic boards connected to the backplane board;

FIG. 2 is a schematic representation of a hardware and software architecture of the electronic boards of the box shown in FIG. 1;

FIG. 3 is a schematic representation of an electronic device for managing the execution of software services of software application/s on the avionics platform shown in FIGS. 1 and 2; and

FIG. 4 is a flowchart of a method according to the invention, for managing the execution of the software services of software application/s, the method being implemented by the electronic management device shown in FIG. 3.

### DETAILED DESCRIPTION

In the description, as well as in the claims, the term “/s)” following the name of an object mean that same refers to one or a plurality of objects of that name, and these terms are identical to the terms “(s)”, and may be replaced by same, if need be, without thereof changing the content of the invention. For example, the expression “of software application/s” then means “of one or a plurality of software applications”, the expression “resistance to breakdown/s” means “resistance to one or a plurality of breakdowns” and the expression “to the service/s” means “to the service or services”.

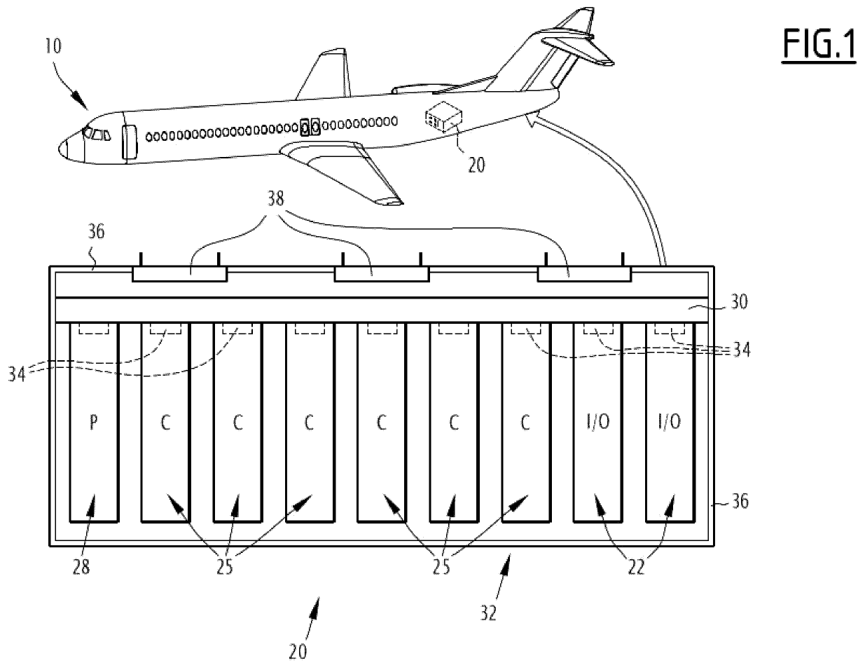

In FIG. 1, an aircraft 10 comprises an avionics platform 20, generally forming an on-board data center, in order to provide different types of services on-board the aircraft 10.

The avionics platform 20 is, e.g., configured to provide cockpit services for a crew of the aircraft 10 and/or maintenance services for the ground and/or entertainment services for passengers on-board the aircraft 10.

The avionics platform 20 forms, e.g., a multimedia server configured to broadcast, via entertainment terminals (not shown), multimedia contents to the passengers of the aircraft 10, in particular during the flight (e.g., movies, TV broadcasts, games or music), and/or information on the progress of the flight (altitude, speed, current position, progress, etc.). As an optional supplement, multimedia server formed by the avionics platform 20 is configured for broadcasting practical information about, e.g., the airport of arrival, e.g., via audio and/or video announcements.

Each entertainment terminal is known per se and is connected to the media server via a local network (not shown) on-board the respective aircraft 10.

Each entertainment terminal is, e.g., attached to or integrated into the seat of the passenger or is attached to or integrated into the backrest of the seat located in front of the seat of the passenger. The seats are typically arranged in rows within the aircraft 10.

The avionics platform 20 comprises at least one electronic communication board 22, a group of electronic computation board/s 25, at least one electrical power supply board 28, the electrical power supply board 25 and the electronic communication board 22 and the computation board 25 being interconnected, e.g., via a backplane board 30, as shown in FIG. 1. The avionics platform 20 is, e.g., made in the form of an electronic box 32 including the backplane board 30, one or a plurality electronic communication boards 22, one or a plurality of electronic computation boards 25 and one or a plurality of power supply boards 28. Each electronic communication board 22, each electronic computation board 25 each electrical power supply board 28, respectively, is connected to the backplane board 30 via a respective backplane connector 34, as shown in FIG. 1. The electronic box 32 further includes a protection case 36 inside which are housed the backplane board 30 and the plurality of electronic communication boards 22, and computation boards 25, and of power supply board/s 28; and external connectors 38 arranged at the periphery of the case 36. The external connectors 38 are intended in particular for connecting the avionics platform 20 to the on-board local network, and to an electrical power supply network, not shown and carried on-board the aircraft 10.

Advantageously, the avionics platform 20 comprises a plurality of boards 22, 25, 28 of the same type, namely a plurality of electronic communication boards 22, a plurality of electronic computation boards 25 and a plurality of power supply boards 28.

The skilled person would then understand that having a plurality of boards 22, 25, 28 of the same type improves the reliability and the availability of the platform 20, the boards of the same type being redundant with respect to each other. Furthermore, the fact of having a large number of boards 22, 25, 28, more particularly electronic computation boards 25, makes it possible to reduce the “granularity” of each board 22, 25, 28 within the electronic box 32, and then to reduce the cost and the need in terms of resources 40 to achieve satisfactory redundancy of the boards 22, 25, 28.

In the example shown in FIG. 1, the avionics platform 20 comprises two electronic communication boards 22, four computation boards 25, and two power supply boards 28. In a variant, the avionics platform 20 comprises two electronic communication boards 22, six electronic computation boards 25 and two power supply boards 28, in order to achieve redundancy for each type of board.

Each electronic communication board 22 is configured to communicate with one or a plurality of equipment items (not shown) external to the platform 20. Each electronic communication board 22 is also called an input-output board, also denoted by I/O (Input/Output) in FIG. 1.

Each electronic computation board 25, also denoted by C in FIG. 1, includes resources 40 and is configured to execute software application/s. The resources 40, also called hardware resources, are physical or logical elements suitable for being made available to the avionics software application or applications.

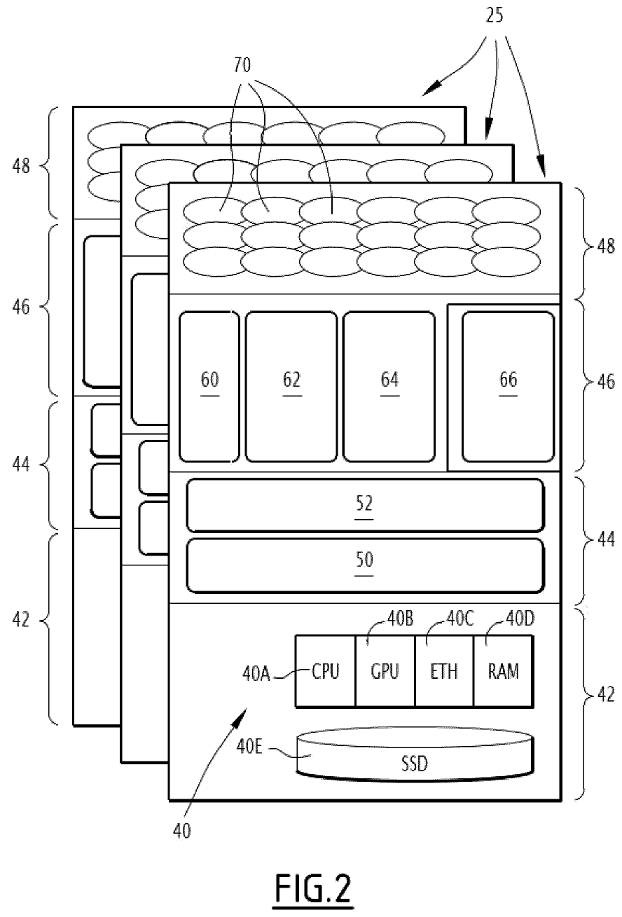

The resources 40 are divided, e.g., into the following categories which are visible in FIG. 2:
resources 40A such as a CPU (Central Processing Unit);
resources 40B such as a GPU (Graphics Processing Unit);
network communication resources 40C, such as Ethernet type resources, denoted by ETH in FIG. 2, to communicate both with the on-board local area network and with a communication network external to the aircraft 10,
40D RAM resources, i.e., RAM (Random Access Memory); and
40E resources of storage memory, i.e., mass memory, such as SSD resources (Solid State Drive).

The skilled person would understand that the CPU 40A and the GPU 40B resources are computational resources, i.e., apt to perform computational operations, the GPU 40B resources being more dedicated to graphic computational purposes and same of CPU 40A to general computational purposes. The skilled person would further understand that the CPU 40A and GPU 40B resources, as well as the other resources of the network communication 40C, the random access memory 40D and the storage memory 40E, are implemented in the form of at least one electronic component integrable on a printed circuit board, and e.g. in the form of an integrated circuit, such as an ASIC (Application Specific Integrated Circuit), or in the form of a programmable logic component such as an FPGA (Field Programmable Gate Array), or in the form of a microcontroller, or else in the form of a specific processor, such as a processor specialized in signal processing or DSP (Digital Signal Processor). The type of electronic component to be used preferentially for producing each type of resource among the aforementioned types of resources is known to a skilled person and is then not described in greater detail.

Advantageously, the group of electronic computation board/s 25 includes resources 40 of all types from the aforementioned group. For example, each electronic computation board 25 includes resources 40 of all types from the aforementioned group. In other words, in the present example, each electronic computation board 25 comprises both CPU resources 40A, GPU resources 40B, network communication resources 40C, random access memory resources 40D and storage memory resources 40E.

The group of electronic computation board/s 25 includes a plurality of electronic computation boards 25, each including the same type or types of resources 40.

Advantageously, the electronic boards of the group of electronic computation boards 25 are all identical, i.e., all include the same resources 40A, 40B, 40C, 40D and 40E. For example, each electronic computation board 25 includes in particular two CPU resources 40A, one GPU resource 40B, two network communication resources 40C, four random access memory resources 40D, and two storage memory resources 40E.

In FIG. 2, each electronic computation board 25 comprises a hardware layer 42, a low-level software layer 44, a middleware layer 46 and a high-level software layer 48, the four layers 42, 44, 46 and 48 being superimposed.

Advantageously, all the electronic computation boards 25 are analogous, or even identical, in terms of hardware, and then have the same hardware layer 42.

Advantageously, all the electronic computation boards 25 have the same software layers, i.e., the same low-level layer 44, the same middleware level layer 46 and the same high-level layer 48 respectively. In other words, the low-level layer 44 is unique for the group of electronic computation boards 25, while being stored distinctly on each of the electronic computation boards 25. Similarly, the middleware layer 46 is unique for the group of electronic computation boards 25, while being stored distinctly on each of the electronic computation boards 25. The high-level layer 48 is also unique for the group of electronic computation boards 25, while being stored distinctly on each of the electronic computation boards 25.

Advantageously again, the low-level layer 44, the middleware 46 and high-level layer 48 are further assembled into a single unique software cluster aggregating all of the software resources.

Each power supply board 28, also denoted by P in FIG. 1, is configured to convert electrical energy received, via one or a plurality of respective external connectors 38, from the power supply network on-board the aircraft 10 into another electrical energy delivered to the electronic communication board 22 and computation board 25. The electrical energy delivered to the electronic boards 22, 25 is typically DC (direct current) electrical energy, and each electrical power supply board 28 then includes an AC-DC converter, when the electrical energy received from the onboard electrical power supply network is alternating electrical energy, or else a DC-DC converter, or DC-DC converter, when said electrical energy received is direct current energy.

The hardware layer 42 of each electronic computation board 25 includes the resources 40, and typically the CPU resources 40A, the GPU resources 40B, the network communication resources 40C, the random-access memory resources 40D, and the storage memory resources 40E.

The low-level software layer 44 comprises a unit 50 for loading a boot program (bootloader), and a unit 52 for providing low-level services including, e.g., a kernel, such as a Linux kernel, and one or a plurality of software drivers.

The middleware 46 comprises an orchestrator 60, a container manager 62, a file manager 64 and a set 66 of configuration files, the orchestrator 60, also called an orchestration device or a management device, being apt to drive one or a plurality of software services 70, also called unitary software services, i.e., to manage the execution of such software services 70. The container manager 62 of each electronic computation board 25 is configured in particular to obtain a list of containers, i.e., software resources, present on the respective electronic computation board 25, so that the orchestrator 60 can then drive the execution thereof. Furthermore, the container manager 62 of one of the electronic computation boards 25 is designated as the master manager among the managers 62 of the different electronic computation boards 25, each manager 62 of the other electronic computation board or boards 25 then being a slave. The master container manager 62 is then further configured to obtain, via each slave manager 62, a list of the containers of each other computation board 25, and then to generate a list of the containers of all the electronic computation boards 25, i.e., a list of all the software resources forming the software cluster described hereinabove.

The high-level software layer 48 comprises said software services 70.

When the avionics platform 20 forms a cockpit services server, the software services 70 correspond, e.g., to a non-avionics system service such as EFB (Electronic Flight Bag), accessible by a pilot through a simple web browser, or else to a service aggregating meteorological data in order to propose alternative trajectories that generate less contrails.

When the avionics platform 20 forms a maintenance services server, the software services 70 correspond e.g., to an on-board predictive maintenance service, or to “health monitoring” services making it possible to detect critical thresholds in the operation of aircraft systems.

When the avionics platform 20 forms an entertainment services server, i.e., the multimedia server, the software services 70 correspond, e.g., to the services provided to the passengers of the aircraft 10: Video On Demand (VOD), Audio On Demand (AOD), games, flight parameters (altitude, speed, etc.) and the progress (e.g., by means of a “moving map”) thereof, audio and/or video announcements by the crew, etc.

According to the invention, the electronic management device 60 comprises an acquisition module 80 for acquiring contextual data for a group of software services 70; a computation module 82 for computing a context from the contextual data acquired and for the group of software services 70; and a launch module 84 for launching the execution of software service/s 70 of the group according to a set of distribution rule/s and depending upon the computed context.

In addition, the electronic management device 60 comprises a stop module 86 for stopping the execution of software service/s 70 with the lowest priority and/or a determination module 88 for determining the group of software services to be executed, prior to the acquisition of contextual data for said group.

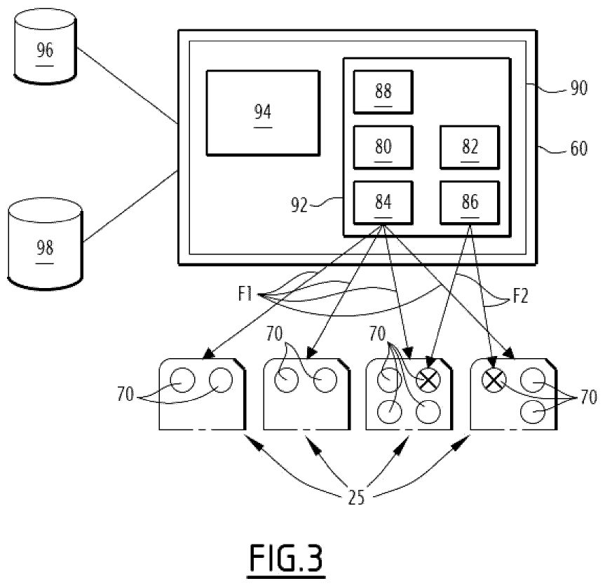

In the example shown in FIG. 3 which represents the electronic management device 60 in general, the electronic management device 60 comprises an information processing unit 90 consisting, e.g., of a memory 92 and of a processor 94.

In the example shown in FIG. 3, the acquisition module 80, the computation module 82, the launch module 84, and, as an optional supplement, the stop module 86 and the determination module 88 are each produced in the form of a software program, or a software brick, which can be run by the processor 94. The memory 92 of the management device 60 is then apt to store an acquisition software, a computation software, a launch software, and, as an optional supplement, a stop software and a determination software. The processor 94 is then apt to execute each of the software programs among the acquisition software, the computation software and the launch software and, as an optional supplement, the stop software and the determination software.

In a variant (not shown), the acquisition module 80, the computation module 82, the launch module 84 and, as an optional supplement, the stop module 86 and the determination module 88 are each produced in the form of a programmable logic component, such as an FPGA (Field Programmable Gate Array), or else of an integrated circuit, such as an ASIC (Application Specific Integrated Circuit).

When the electronic management device 60 is produced in the form of one or a plurality of software programs, i.e., in the form of a computer program, same is further apt for being recorded on a computer-readable medium (not shown). The computer-readable medium is, e.g., a medium apt to store the electronic instructions and to be coupled to a bus of a computer system. As an example, the readable medium is an optical disk, a magneto disk, a ROM memory, a RAM memory, any type of non-volatile memory (e.g., EPROM, EEPROM, FLASH, NVRAM), a magnetic board or an optical board. A computer program containing software instructions is then stored on the readable medium.

In the example shown in FIG. 2, the skilled person would understand that the management device 60, also called the orchestrator 60, uses resources 40 of the electronic computation board 25 on which same is installed, for the implementation thereof. In such example, the orchestrator 60 is then configured to acquire the contextual data for the group of software services 70, then to compute the context from the acquired contextual data and for the group of software services 70, and finally to launch the execution of software service/s 70 of the group according to the set of distribution rule/s and depending upon the computed context. In addition, the orchestrator 60 is also configured to stop the execution of software service/s 70 the lowest priority software service/s and/or to determine the group of software services to be executed, prior to the acquisition of contextual data for said group.

The acquisition module 80 is configured to acquire contextual data for a group of software services 70 to be executed on the avionics platform 20. The acquisition module 80 is, e.g., configured to acquire said contextual data from a first database 96, also called the contextual database.

The contextual data include, e.g., for each software service 70: a maximum number of resources 40 used by said service 70; an operating requirement of said service 70 equal to resistance to breakdown/s or non-resistance to breakdown/s; and if the operating requirement of said service 70 is equal to resistance to breakdown/s, a number of breakdown/s said service 70 should withstand.

In addition, the contextual data include, if the operating requirement of a respective 70 service is equal to non-resistance to breakdown/s, a level of availability required for said service 70. The level of availability of a service is generally expressed as a percentage of the time during which the service is operational.

In addition, the contextual data include more global data relating to a state of the electronic computation boards 25, with, e.g., for each computation board 25, a breakdown state or, where appropriate, a partially unusable state. When a computation board 25 is in a normal operating state, thereof is not necessarily mentioned in the contextual data, since the respective computation board 25 is then in the nominal state thereof.

In addition again, the contextual data include data relating to operational conditions specific to the aircraft 10, such as an indication of a current phase of flight of the aircraft 10, and/or such as a status of each avionics system on-board the aircraft 10, including, in particular, for each avionics system, a breakdown state, where appropriate. Again, when the avionics system is in a normal operating state, thereof is not necessarily mentioned in the contextual data, as the respective avionics system is then in the nominal state thereof.

The computation module 82 is configured to compute, from the acquired contextual data, a context for the group of software services 70.

The context is, e.g., a prioritization of the software services 70 with respect to one another, and the computation module 82 is then configured to compute a level of priority for each software service 70 respectively, on the basis of the contextual data acquired.

The level of priority is, e.g., higher for a service 70 with an operating requirement equal to resistance to breakdown/s than for a service 70 with an operating requirement equal to non-resistance to breakdown/s. In other words, according to the present example, the level of priority is higher for a service that should withstand one or a plurality of breakdowns, i.e., that has a guarantee of resistance to one or a plurality of breakdowns, than for a service that may not withstand one or a plurality of breakdowns, i.e., that does not have a guarantee of resistance to one or a plurality of breakdowns.

In addition to the present example, for a software service 70 with an operating requirement equal to resistance to breakdown/s, the level of priority also depends on the number of breakdown/s to the service 70 should withstand. Advantageously, the level of priority for a service 70 that should withstand N+1 breakdowns is greater than the level of priority for a service 70 that should withstand N breakdown/s, N being an integer greater than or equal to 1.

In addition, the computation module 82 is configured to compute the level of priority of each software service 70 according to a phase of flight of the aircraft 10, included in the contextual data, and to then compute the level of priority of each software service at each change of phase of flight, the level of priority being likely to vary from one phase of flight to another.

The phase of flights are typically as follows: parking (the aircraft 10 is parked), taxiing, takeoff, ascent, cruise, descent, landing.

As an example, a software service 70 for loading a flight plan is essential when the aircraft 10 is in the phase of flight equal to parking, so that the aircraft 10 can then carry out the flight, and the level of priority of the software service 70 is then higher in the parking phase than in the other phase of flights. On the other hand, other software services 70 have a higher level of priority for the phase of flights equal to takeoff, ascent, cruise, descent and landing than for the phase of flight equal to parking. For example, entertainment services, also known as IFE (In-Flight Entertainment) services, have a high level of priority during the cruise.

When, in addition, the computation module 82 is configured to compute the level of priority of each software service 70 as a function of both a phase of flight of the aircraft 10 and a resistance to N breakdown/s, the level of priority is computed as a priority depending upon the phase of flight, then secondarily depending upon the resistance to N breakdown/s. According to such supplement, the level of priority of each software service 70 is typically computed first according to different value ranges (e.g., every 100) depending on the phase of flight forming the context; then within each value range, the level of priority being refined according to the required resistance to N breakdown/s.

In addition again, when the contextual data further include, for each software service 70 having an operating requirement equal to non-resistance to breakdown/s, a respective level of availability of said service 70, the computation module 82 is configured to compute the level of priority of each software service 70 according to said level of availability.

According to such supplement, the level of priority is, e.g., all the higher the level of availability is high. In other words, the software services 70 have all the lower priority for the execution thereof as the level of availability thereof is low.

The launch module 84 is configured to launch the execution of one or a plurality software services 70 of the group according to the distribution rule/s of the software services 70 on the platform 20 and depending upon the computed context.

The set of distribution rule/s typically includes one or a plurality of rules from the group consisting of:
a first rule according to which the execution of a service 70 of higher level of priority has priority over the priority of a service 70 of lower level of priority;
a second rule according to which the available number of resources 40 of the platform 20 is greater than or equal to the sum of the maximum numbers of resources 40 used by the software services 70 executed; and
a third rule according to which the number of resources 40 available after N breakdown/s is greater than the sum of maximum number/s of resources 40 used by the service/s 70, which should withstand N breakdown/s, N being an integer greater than or equal to 1.

Advantageously, the set of distribution rule/s include all the rules among the aforementioned group, i.e., includes the first, second and third rules.

The stop module 86 is configured to stop the execution of the lowest priority software service/s if the available number of resources 40 is insufficient to launch the execution of a new software service 70. The software service/s 70 with the lowest priority are same with the lowest level/s of priority.

For the distribution of the software services among the resources 40 of the avionics platform 20, in particular among the resources 40 of the different electronic computation boards 25, the launch module 84 is then configured, e.g., to launch the execution of the software services 70 as long as there are sufficient resources available, and by preferentially launching the execution of the software services 70 in descending order of levels of priority, i.e., by first launching the execution of the highest priority software services 70.

Then, if there is no longer any resource 40 available to launch the execution of a new software service 70, the stop module 86 is configured to stop the execution of the least priority software service/s 70, i.e., in increasing order of levels of priority, until there are again sufficient resources 40 available for the execution of the new software service/s 70, i.e., to recover sufficient resources 40 to be able to be executed the new software service/s 70, while following the hierarchy of levels of priority between the new software services 70 to be executed and the software services 70 being executed. In other words, the need to launch the execution of a new software service 70 leads to stopping the execution of a software service 70 that is currently running only if the new software service 70 to be executed has a higher level of priority than that of the software service 70 being executed.

As an optional addition, the determination module 88 is configured to determine the group of software services 70 to be executed, more particularly to verify a new group of software services 70 to be executed before the software services 70 of said new group can be launched by the launch module 84.

According to such optional complement, the determination module 88 is configured, e.g., to receive a new group of software services 70, e.g., from a second database 98, also called the software service base; then to verify the received group of software services 70 according to a predefined set of verification rule/s, and finally to replace the current group of software services 70 by the new received group of software services 70 if same is considered correct following the verification; the current group of software services 70 being maintained otherwise, i.e., if the new group is considered incorrect following the verification. The determination module 88 is typically configured to verify the new received group of software services 70 from a set of requirements. The set of requirements includes, for each context and each software service 70, an operational requirement, such as a level of availability higher than a predefined minimum level (e.g., 95%) for the context in question.

The context typically depends on the state of the resources 40 and on operational conditions specific to the aircraft 10. For example, the state of the resources is evaluated for each resource 40 with a value chosen from breakdown, partially unusable, and available. The operational conditions specific to the aircraft 10 are defined, on the one hand, by the phase of flight and, on the other hand, by the status of the avionics systems, the status of each avionics system typically having a value chosen from among breakdown and operational. The context is then expressed, e.g., in the form of a triplet including a number of resource/s 40 broken down, the phase of flight concerned, and an indication of possible avionics system breakdown/s. A context defined in the form of the triplet (0, cruise, hydraulic system breakdown) means that the avionics platform 20 is fully operational (no resource 40 broken down), that the aircraft 10 is in the phase of flight equal to cruise, and that there is a breakdown of the hydraulic system.

The determination module 88 is then advantageously configured to perform the verification of the new group received of software services 70 on the basis of all the requirements and via statistical models, or else via Monte Carlo simulations.

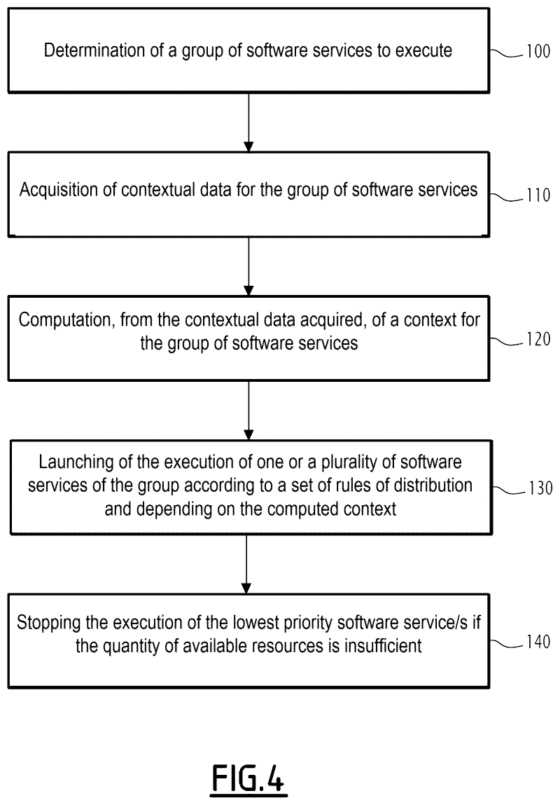

The operation of the avionics platform 20, and more particularly of the electronic management device 60, or orchestrator 60, will now be explained, in particular using FIG. 4 representing a flowchart of the method, according to the invention, for managing the execution of software services 70, the method being implemented by the management device 60.

During an optional initial step 100, the management device 60 determines, via the determination module 88 thereof, the group of software services 70 to be executed, and more particularly verifies whether a new group of software services 70 received from the second database 98, is correct and can then replace the current group of software services 70.

During the determination step 100, the determination module 88 then receives the new group of software services 70, then verifies same according to the set of verification rule/s and substitutes same for the current group of software services 70 if the new group is correct. On the other hand, if the new group is incorrect with regard to set of verification rule/s, then the determination module 88 discards same and keeps the current group of software services 70.

The skilled person would understand that the current group of software services 70 is a predefined group of software services 70 assumed to be correct or else a group of software services 70 priorly determined, i.e., having been previously verified according to the set of verification rule/s, then considered to be correct and having then replaced a previous group of software services 70.

During the next step 110, the management device 60 acquires, via the acquisition module 80 thereof, the contextual data for the group of software services 70 to be executed on the avionics platform 20, and, e.g., for the group determined during the preceding optional determination step 100.

During a subsequent computation step 120, the management device 60 computes, via the computation module 84 thereof, the context for the group of software services 70 from the contextual data acquired during the preceding acquisition step 110.

During the computation step 120, the computation module 84 typically computes the level of priority for each software service 70, firstly according to whether or not the operating requirement for said service 70 is equal to resistance to breakdown/s, and then according to the number N of breakdown/s said service 70 should withstand when the operating requirement is equal to resistance to breakdown/s, or depending upon the required level of availability for said service 70 when the operating requirement is equal to non-resistance breakdown/s.

In addition, the level of priority of each software service 70 depends on the phase of flight of the aircraft 10, the computation module 84 then computes the level of priority for each software service 70 depending upon, furthermore, the phase of flight of the aircraft 10.

At the end of the computation step 120, the management device 60 launches, via the launch module 86 thereof and during a following step 130, the execution on the avionics platform 20 of one or a plurality of software services 70 of the group, as represented by the arrows F1 in FIG. 3, depending upon the context computed during the preceding computation step 120 and according to the set of distribution rule/s.

During the launching step 130, the launching module 86 typically takes into account one or a plurality of the first, second and third distribution rules, and preferably of each of the first, second and third distribution rules, to define the software service or services 70 the execution of which is to be launched.

The launch module 86 launches, e.g., the execution of the software services 70 of the current group as long as there are sufficient resources available, and by ordering the execution launches from the software services 70 with the highest priority to the software services 70 with the lowest priority, i.e., by starting with the software services 70 with the highest levels of priority, then ending with same with the lowest levels of priority.

At the end of the launching step 130, if there is no longer any resource 40 available to launch the execution of a new software service 70, the management device 60 stops, during a next step 140 and via the stop module 86 thereof, the execution of one or a plurality of software services 70, as represented by the arrows F2 in FIG. 3, advantageously of the software services 70 with the lowest priority, until sufficient resources 40 are released to be able to execute the new software services 70 which have to be executed.

During the stop step 140, the stopping of the execution of software service/s 70 is preferentially performed in increasing order of the levels of priority of the software services 70 being executed, and by comparing the levels of priority of the software services 70 being executed with the levels of priority of the new software services 70 to be executed, the execution of a software service 70 being executed being stopped only if the new software service 70 to be executed has a higher level of priority than the level of priority of the software service 70 being executed.

At the end of the stop step 140, the management device 60 returns to the determination step 100 if a new group of software services 70 has been received, or to the acquisition step 110 to acquire new contextual data, or else to the computation step 120 to compute the context again for the group of software services 70, e.g., in the event of a change of phase of flight.

As an optional supplement, the computed context of each software service 70 depends on the phase of flight of the aircraft 10, and the computation module 84 then computes the context for the software service group 70 at each change of phase of flight, from a current phase of flight to a subsequent phase of flight, and then computes a subsequent context for the subsequent phase of flight.

According to such optional supplement, the software service/s 70 executed during the subsequent phase of flight then depend on the subsequent context computed. The execution of the software service/s 70 to be newly executed during the subsequent phase is then launched during the next launching step 130. The execution of the software service/s 70 executed during the current phase of flight and no longer to be executed during the subsequent phase is stopped during the next stop step 140.

The method for managing the execution of software services 70 and the electronic management device 60 according to the invention then serve to distribute the limited resources 40 of the avionics platform 20 in the best way possible between the software services 70, depending upon the context computed from the contextual data.

The contextual data include, in particular, for each software service, a maximum number of resources allocated to the service, an indication according to which the service should or should not withstand one or a plurality of breakdowns, and, where appropriate, the number of breakdown/s same should withstand and/or a required level of availability; and the distribution of the limited resources 40 then gives preference to the software services 70 which should be the most resistant to breakdowns, and, in the absence thereof, which provide the highest level of availability.

Advantageously, the phase of flight of the aircraft 10 is taken into account, which makes it possible to define a resistance to breakdown/s and/or a level of availability for each software service 70 according to the phase of flight, and then to optimize the distribution of resources also according to the phase of flight. In doing so, the prioritization of software services 70 varies from one phase of flight to another.

It should thereby be understood that the management method and the management device 60 according to the invention serve to better manage the execution of the software services 70 with limited resources 40, and then to improve the operation of the avionics platform 20.

1. A method for managing execution of software application services on an avionics platform carried on-board an aircraft, the method implemented by an electronic management device and comprising:
acquiring contextual data for a plurality of software services to be executed on the avionics platform, the contextual data comprising, for each software service, (i) a maximum number of resources used by the service (ii) an operating requirement of the service equal to resistance to breakdown/s or non-resistance to breakdown/s, and (iii) if the operating requirement of the service is equal to resistance to breakdown/s, a number of breakdown/s to which the service has to be resistant;
computing, from the acquired contextual data, a context for the plurality of software services; and
launching execution of one or more of the software services according to a set of distribution rule/s of software services on the platform and depending upon the computed context.

2. The method according to claim 1, wherein said computing a context comprises computing a level of priority for each software service, respectively, the level of priority being higher for a service with an operating requirement equal to resistance to breakdown/s than for a service with an operating requirement equal to non-resistance to breakdown/s.

3. The method according to claim 2, wherein the level of priority depends on the number of breakdown/s the service should withstand.

4. The method according to claim 3, wherein the level of priority for a service which should withstand N+1 breakdowns is higher than the level of priority for a service which should withstand N breakdown/s, N being an integer greater than or equal to 1.

5. The method according to claim 2, wherein the set of distribution rule/s includes one or more rules from a group consisting of: a first rule according to which execution of a service of higher level of priority takes precedence over execution of a service of lower level of priority, a second rule according to which the available number of resources of the platform is greater than or equal to the sum of the maximum numbers of resources used by the software services executed, and a third rule according to which the number of resources available after N breakdown/s is greater than the sum of maximum number/s of resources used by the service/s which should withstand N breakdown/s, N being an integer greater than or equal to 1.

6. The method according to claim 5, wherein the set of distribution rule/s includes all rules among the group.

7. The method according to claim 1, wherein the context of each software service depends on a phase of flight of the aircraft, and wherein the method further comprises, at each change of phase of flight from a current phase to a subsequent phase:
computing a subsequent context for the subsequent phase of flight, the software service/s executed in the subsequent phase of flight depending upon the computed subsequent context;
stopping execution of the software service/s in the current phase of flight that are no longer to be executed in the subsequent phase; and
launching execution of the software service/s to be newly executed in the subsequent phase.

8. The method according to claim 7, wherein said computing a context comprises computing a level of priority for each software service, respectively, the level of priority being higher for a service with an operating requirement equal to resistance to breakdown/s than for a service with an operating requirement equal to non-resistance to breakdown/s, wherein the level of priority of each software service depends on the phase of flight of the aircraft, and wherein said computing a subsequent context comprises computing subsequent levels of priority of the software services for the subsequent phase of flight, and the software service/s executed during the subsequent phase of flight then depend on the computed subsequent levels of priority.

9. The method according to claim 1, further comprising stopping execution of the least priority software service/s if the number of available resources is insufficient to launch execution of a new software service.

10. The method according to claim 9, wherein, during said computing a context, a level of priority is computed for each software service, respectively, the level of priority being higher for a service with an operating requirement equal to resistance to breakdown/s than for a service with an operating requirement equal to non-resistance to breakdown/s, and wherein the software service/s with the lowest priority are the software service/s with the lowest level/s of priority.

11. The method according to claim 1, wherein the contextual data further include, for each software service, if the operating requirement of the service is equal to non-resistance to breakdown/s, a level of availability of the service, and wherein software services have lower priorities for execution when their levels of availability are low.

12. The method according to claim 1, further comprising, before said acquiring:
determining the plurality of software services to be executed, comprising receiving a new plurality of software services; and
verifying the received plurality of software services according to a predefined set of verification rule/s; and
if the received plurality of software services is considered correct during said verifying, then changing the plurality of software services to be executed to the received plurality of software services;
otherwise not changing the plurality of software services to be executed.

13. A non-transitory computer-readable medium including a computer program including software instructions which, when executed by a computer, implement a method according to claim 1.

14. An electronic device for managing execution of software services on an avionics platform carried on-board an aircraft, the electronic management device comprising:
an acquisition module configured to acquire contextual data for a plurality of software services executed on the avionics platform, the contextual data comprising, for each software service a maximum number of resources used by the service, an operating requirement of the service equal to resistance to breakdown/s or non-resistance to breakdown/s, and if the operating requirement of the service is equal to resistance to breakdown/s, a number of breakdown/s to which the service has to be resistant;
a processor computing, from the acquired contextual data, a context for the software services; and
a launcher launching execution of one or more of the software services according to a set of distribution rule/s of software services on the platform and depending upon the context computed by said processor.

15. An avionics system intended to be carried on-board an aircraft, comprising:
an avionics platform including resources for execution of software services; and
an electronic management device according to claim 14 for managing execution on said avionics platform of software services.
